(19) United States
(12) Patent Application Publication
(10) Pub. No.: US 2011/0251958 A1
(43) Pub. Date: Oct. 13, 2011

(54) Method of Controlling a Device Able to Function in a Mode With or Without Code Verification to Effect a Transaction

(75) Inventors: Yann-LoÏc AUBIN, Nanterre (FR); JérÔme AJDENBAUM, Nanterres (FR)

(73) Assignee: OBERTHUR TECHNOLOGIES, Levallois-Perret (FR)

(21) Appl. No.: 12/839,985

(22) Filed: Jul. 20, 2010

(30) Foreign Application Priority Data
Apr. 13, 2010 (FR) 1052808

(51) Int. Cl. G06Q 40/00

(52) U.S. Cl. 705/44

(57) ABSTRACT

The invention relates to a method of controlling a device able to function in a mode with code verification or in a mode without code verification to effect a transaction, the method including a step of authenticating the device, an optional step of verifying a code, and a stage of continuing the transaction, wherein the method further includes a first verification step of verifying whether the device is functioning in the mode without code verification; and
if so, the stage of continuing the transaction includes a step of making the transaction secure including determining a history of preceding transactions of the device in the mode without code verification, processing the transaction securely as a function at least of the history, and updating the history. The invention relates to a device able to function in accordance with such a control method.

### BACKGROUND OF THE INVENTION

The general field of the present invention is that of devices able to effect a transaction in a mode with code verification or in a mode without code verification, such as microcircuit cards, also known as smart cards (notably microcircuit cards conforming to the ISO 7816 standard).

The invention applies more particularly, but not exclusively, to microcircuit cards using the Europay Mastercard Visa (EMV) protocol, also known as the Chip and PIN protocol.

Generally speaking, a microcircuit card is designed to communicate with a device external to the card, also known as a terminal or reader. These cards are used to effect various types of transaction, such as payment transactions and cardholder authentication transactions, for example. Microcircuit cards for banking applications (credit cards, debit cards, etc.) are able to communicate with payment terminals, for example.

The EMV protocol is the standard protocol most used worldwide, notably for enabling secure payment transactions to be effected by microcircuit cards.

The EMV protocol was designed to reduce the risk of fraud during a payment transaction by enabling authentication of the card and the cardholder. This authentication process uses a combination of cryptograms (or encrypted keys) and digital signatures and may require entry by the cardholder of a code (usually called the PIN or personal code).

Depending on the type of card used, the circumstances or the amount concerned, an EMV card can function in an online mode or in an offline mode. In the online mode, the EMV card is able to communicate via a terminal with the corresponding issuing entity (for example the bank that issued the card) in order to verify that the current transaction is legitimate. In contrast, in the offline mode the EMV card applies prestored verification criteria to decide whether the transaction should be authorized or refused.

FIG. 1 represents an example of an EMV protocol payment transaction using a smart card able to function in the mode with or without code verification.

An EMV payment smart card generally contains various banking applications, for example to function in credit card mode or debit card mode at a point of sale or to interact with an automated teller machine.

It is assumed here that the cardholder inserts the payment card into a compatible payment terminal. The EMV protocol generally proceeds in three stages in this situation.

The first stage (E100) of the EMV protocol authenticates the smart card used. To do this, the terminal sends (E101) the payment card a SELECT APPLICATION command with 1PAY.SYS.DDF01 as the Application IDentifier (AID) parameter. This command asks the card for the applications that it is capable of running. In response, the card sends (E102) a list of the applications that it is able to run. The cardholder can then act via the payment terminal to select the transaction mode required, thus triggering (E104) the sending of a SELECT APPLICATION command to the card with the AID of the selected application as a parameter. The terminal also sends (E104) a GET PROCESSING OPTIONS command to the card in order to start the transaction.

The terminal then receives (E106) from the payment card a data set or “records” including information specific to the card (account number, expiry date, etc.), a digital signature for authenticating the card, control parameters to be used to effect the transaction, and Card Data Object Lists (CDOL) described in more detail below.

When the card authentication stage has been completed, the EMV protocol proceeds to the cardholder authentication stage (E107). The terminal determines the cardholder authentication method to be applied as a function of information previously received in the control parameters. In particular, this stage enables the payment terminal to determine whether the transaction is effected in the mode with or without code verification.

If, as in most situations, the mode with code verification is selected, the cardholder is prompted to enter his PIN using the keypad with which payment terminals are generally provided. The terminal then sends (E108) the payment card a VERIFY request for verification of the PIN entered by the cardholder. The payment card then compares the PIN entered by the cardholder with the authentic PIN contained in its memory.

If the PIN entered is deemed valid, the payment card sends (E110) a 0x9000 OK message to the terminal. If not, the card sends (E110) a 0x63Cx refusal message to the terminal, where x is the number of PIN entry attempts remaining before the card blocks the transaction in progress (and future transactions). Only the situation of offline PIN verification is of interest here, i.e. the situation in which the terminal does not call the card issuer during the PIN verification process.

In contrast, if the mode without code verification is selected, no PIN verification is carried out. This situation arises if the terminal is unable to verify a PIN, for example. In this situation, authentication may require the handwritten signature of the cardholder.

Once the cardholder authentication stage has been completed, the protocol initiates (E113) the transaction verification stage. To do so, the terminal sends (E112) the EMV card an APDU GENERATE AC or GAC command. This command includes a description of the transaction in progress and is obtained by concatenating data specified in a CDOL previously sent by the card. The GAC command typically contains information such as the amount of the transaction in progress, the currency used, the type of transaction, etc.

The EMV card then executes (E114) an analysis step including verification of a plurality of criteria. The number and nature of these verifications are not standardized in the EMV protocol. Nevertheless, some particular verifications are imposed for EMV devices using the CCD (Common Core Definitions) option of the EMV protocol.

Following this analysis step, the EMV card sends (E116) the terminal in response a cryptogram (or cryptographic certificate) containing a Message Authentication Code (MAC) typically encrypted using a cryptographic key stored in the card. The response of the card depends notably on the card parameter settings made by the card issuing entity (referred to as the issuer in the remainder of this document).

In the FIG. 1 example, the card sends an Authorization ReQuest Cryptogram (ARQC) indicating that it wishes to continue the transaction online, for example via the server of the issuer of the EMV card used (online mode). The terminal then sends (E118) the ARQC to the issuer, which effects remote verifications (E120) to be sure that the transaction is valid. In response the terminal receives (E122) an ARPC encrypted message indicating the issuer's decision. The terminal then transmits (E124) this message to the EMV card.

If the card accepts the transaction, it responds by sending (E126) the terminal a TC (transaction accepted) cryptogram. If not, the EMV card sends the terminal an AAC (transaction refused) cryptogram.

Note that it is nevertheless not always necessary, nor even possible, to continue the transaction online. For example, if the card detects that continuing the transaction online is not necessary, it sends a TC or AAC cryptogram in response to the GAC command from the terminal.

Note also that if the EMV card implements the COD option of the EMV protocol, it adds a CVR (Card Verification Results) message in response to the GAC command in the step E116. The message CVR in particular makes it possible to indicate the reasons associated with the decision of the EMV card following the GAC command. This message can in particular be transmitted by the terminal to the issuer of the EMV card for internal use.

In the final analysis, the devices for effecting transactions in both modes (with or without code verification), such as EMV microcircuit cards, for example, are generally made secure in such a manner as to resist effectively the more common frauds. However, new types of fraud have recently been identified, calling into question the reliability of transactions conducted using this type of device.

The document entitled “Chip and PIN is Broken” by Ross Anderson et al. describes in particular the emergence of a new MITM (Man-In-The-Middle) attack against communications protocols such as the EMV protocol, for example. This type of attack places an MITM component between the terminal and the EMV card in order to intercept and modify data exchanged between these two entities during a transaction.

To be more precise, when the terminal sends a VERIFY request during the step E108, for example, that request can be intercepted by an MITM component that sends the terminal in response a 0x9000 OK message, regardless of the code entered by the user. Consequently, the terminal considers the verification of the PIN entered by the cardholder to be positive and then initiates the stage E113 for verifying the transaction by sending a GAC command to the EMV card.

The EMV card for its part receives no VERIFY request from the terminal during the stage E107. Thus on reception of the GAC command from the terminal (E112), the EMV card deduces that the terminal is not responsible for verifying the PIN (which is a plausible outcome of the cardholder authentication stage) and thus considers that the current transaction is being effected in the mode without code verification. The EMV protocol does not enable either the terminal or the EMV card to detect this inconsistency in the remainder of the transaction, which thus constitutes a breach of the protocol.

There is therefore at present a need to make transactions without code verification secure, notably in order to prevent MITM attacks as described above.

### OBJECT AND SUMMARY OF THE INVENTION

To this end, the invention provides a method of controlling a device able to function in a mode with code verification or in a mode without code verification to effect a transaction, the method including:
a step of authenticating the device;
an optional step of verifying a code; and
a stage of continuing the transaction;

wherein the method further includes a first verification step of verifying whether the device is functioning in the mode without code verification; and
if so, the stage of continuing the transaction includes a step of making the transaction secure including:
a substep of determining a history of preceding transactions of the device in the mode without code verification;
a substep of processing the transaction securely as a function at least of the history; and
a substep of updating the history.

The invention advantageously makes it possible to limit the risk of frauds associated with transactions in the mode without code verification. As explained above, this type of transaction entails some risks, resulting notably from the emergence of MITM attacks.

The invention is also advantageous in that it impacts only the operation of the device itself. This makes it possible to avoid modifying external devices liable to communicate with said device to effect the transaction. EMV terminals in particular are now very widespread and their replacement (or modification) on a large scale would generate very high costs.

In one particular implementation, the determination step is effected after a step of receiving a cryptogram request during the stage of continuing the transaction.

If the device uses the EMV protocol, for example, it can be configured to carry out the determination step following reception of a GAC command.

The transactions may moreover be payment transactions, the history including at least one of the following parameters:
the number of uses of the device in the mode without code verification; and
the running total for all transactions without code verification.

Alternatively, the history contains only one of the above parameters.

Moreover, if the transactions concerned are payment transactions, the substep of secure processing of the transaction can also take account of the individual amount of the transaction in progress.

In one particular implementation, the secure processing substep includes at least one of the following actions:
sending a request to continue the transaction online;
sending a warning message; and
rejecting the transaction.

Moreover, if the transactions are payment transactions, the secure processing substep may further include a verification substep of verifying whether the number of uses of the device in the mode without code verification exceeds a predetermined minimum number and if the running total for all transactions without code verification exceeds a predetermined minimum amount, and, if so, sending a request to continue said transaction online.

This implementation offers some degree of flexibility in making transactions in the mode without code verification secure. If the transaction in progress is considered at risk, it is not necessarily blocked. For example, the issuer of the device may carry out additional verifications remotely to be sure that the transaction in progress is legitimate.

In another implementation, a command is received in response to the request to continue the transaction online and the secure processing substep includes rejecting the transaction:
if the received command includes a parameter indicating refusal of said request to continue the transaction online;
if the number of uses of the device in the mode without code verification exceeds a predetermined maximum number; and
if the cumulative amount of all transactions in the mode without code verification exceeds a predetermined maximum number.

This implementation is advantageous because the holder of a payment card might, for example, need to effect a series of payment transactions offline in the context of normal use of the card.

A variant of this implementation determines whether the request to continue online has been accepted as a function of the state of the parameter in the received command, the method further including a preliminary step of sending a request for insertion of said parameter in the command to be sent in response to the request to continue the transaction online.

Moreover, if the result of the first verification step is negative, the history may be reinitialized.

In a different implementation, the device is able to effect a transaction in a communications mode with or without contact, the mechanism for making the transaction secure being determined as a function of the communications mode used by the device.

In one particular implementation, the steps of the control method of the invention are determined by computer program instructions.

Consequently, the invention further provides a computer program on an information medium, adapted to be executed by a microprocessor, or more generally in a computer, and including instructions adapted to execute the steps of a control method as described above.

This program may use any programming language and take the form of source code, object code or a code intermediate between source code and object code, such as a partially-compiled form, or any other desirable form.

The invention further provides an information medium readable by a microprocessor, or more generally by a computer, this information medium containing instructions of a computer program as referred to above.

The information medium may be any entity or device capable of storing the program. For example, the medium may include storage means, such as a read only memory (ROM), for example a compact disk (CD) ROM or a micro-electronic circuit ROM, or magnetic storage means, for example a floppy disk or a hard disk.

Moreover, the information medium may be a transmissible medium such as an electrical or optical signal, which may be routed via an electrical or optical cable, by radio or by other means. The program of the invention may in particular be downloaded over an Internet type network.

Alternatively, the information medium may be an integrated circuit incorporating the program, the circuit being adapted to execute the estimation and signaling method of the invention or to be used in its execution.

In a correlated way, the invention provides a device adapted to function in a mode with code verification or in a mode without code verification to effect a transaction, the device including:
means for authenticating said device;
means for verifying a code; and
means for continuing the transaction;

wherein the device includes verification means able to verify whether the device is functioning in the mode without code verification and, if so, to trigger means for making the transaction secure including:
means for determining a history of preceding transactions of the device in the mode without code verification;
means for processing the transaction securely as a function at least of the history; and
means for updating the history.

It should be noted that the control method of the embodiments of the invention described above and the advantages of each of them apply in the same manner to the device of the invention.

### BRIEF DESCRIPTION OF THE DRAWINGS

Other features and advantages of the present invention emerge from the description given below with reference to the appended, which show a non-limiting implementation of the invention. In the drawings:

FIG. 1 represents in flowchart form the main steps of communication between a terminal and an EMV card using the known EMV protocol;

FIG. 2 represents a microcircuit card of one particular embodiment of the invention;

FIG. 3 represents an example of an external device adapted to communicate with the FIG. 2 device;

FIG. 4 represents in flowchart form the main steps of the control method of one particular implementation of the invention;

FIG. 5 represents in flowchart form the main steps of the control method of a variant of the FIG. 4 implementation of the invention; and

FIG. 6 represents a microcircuit card of a variant of the FIG. 2 embodiment of the invention.

### DETAILED DESCRIPTION OF ONE EMBODIMENT

The invention relates to a method of controlling a device able to function with or without code verification to effect a transaction. The invention applies particularly to cards (notably smart cards) adapted to execute a transaction to the EMV standard.

The invention is not limited to cards, however, but relates more generally to any device able to effect a transaction in a mode with or without code verification.

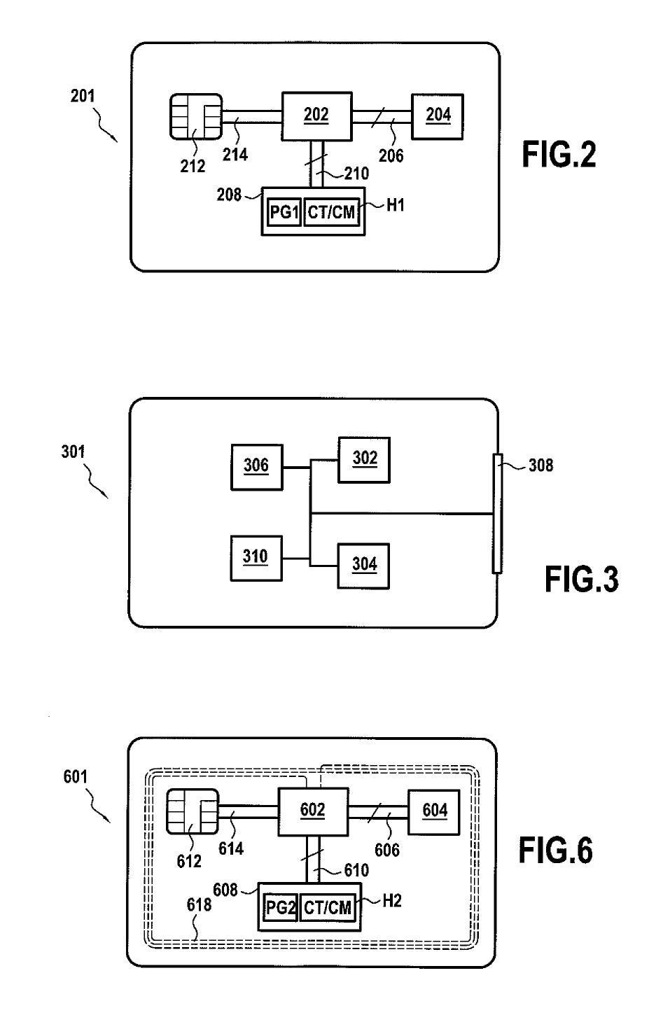

FIG. 2 represents a microcircuit card 201 of one embodiment of the invention.

This microcircuit card 201 includes a microprocessor 202 able to access a random-access memory 204 via a bus 206 and a non-volatile memory (for example an EEPROM) 208 via a bus 210.

The microcircuit card 201, or to be more precise the microprocessor 202, is able to exchange data with an external device (terminal) 301 represented in FIG. 3 by a communications interface 212 consisting of contacts.

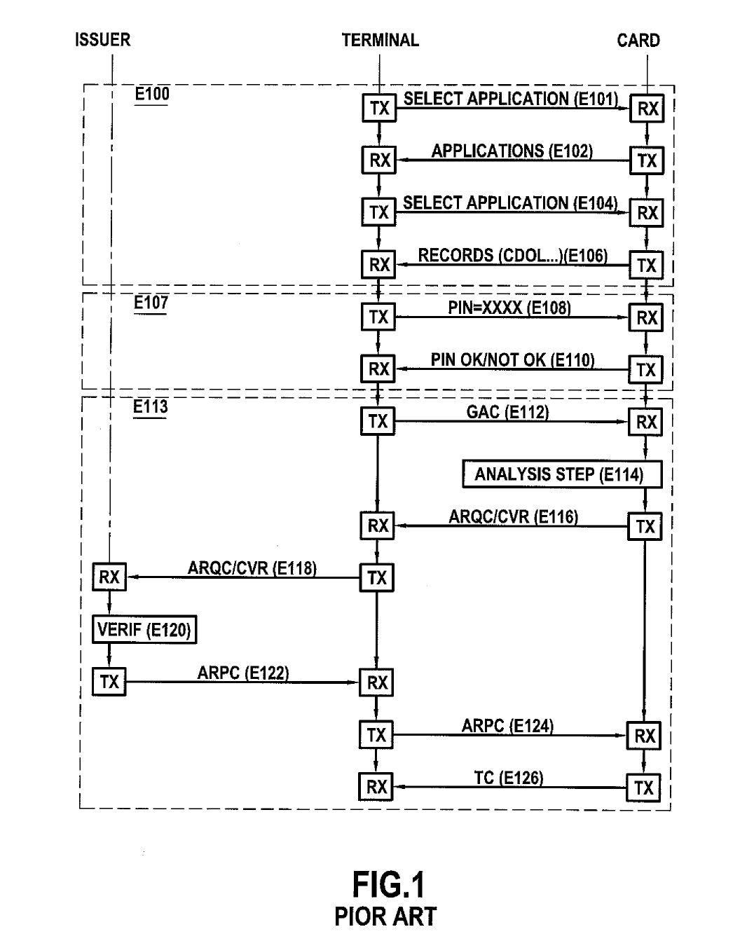

FIG. 1 shows two rows of contacts 214 enabling exchange of data between the terminal 301 and the microprocessor 202.

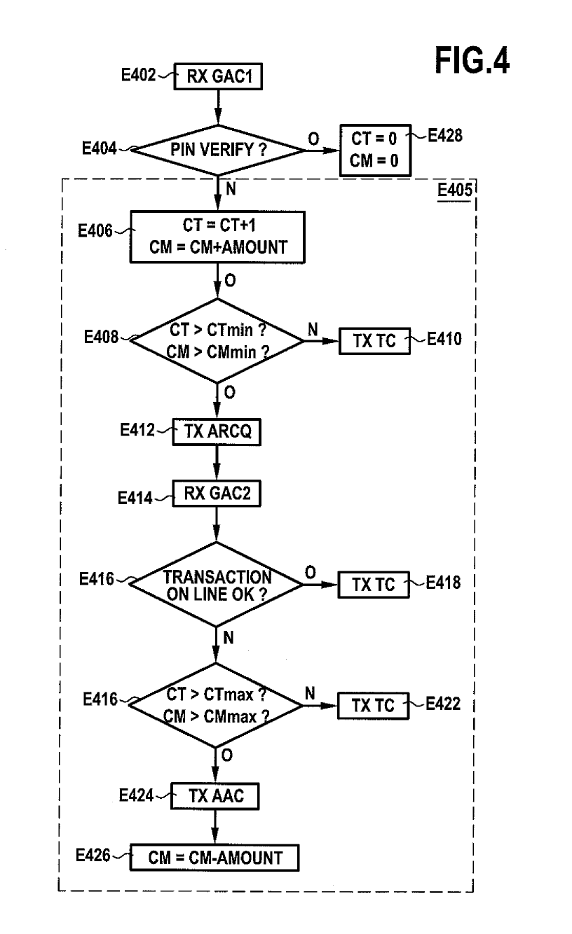

The non-volatile memory 208 of the microcircuit card 201 constitutes an information medium of the invention. It contains a computer program PG1 of the invention including instructions for executing a control method of the invention having main steps E402 to E428 that are represented in flowchart form in FIG. 4.

Referring to FIG. 3, the terminal 301 in this example has the hardware architecture of a computer. It includes a processor 302, a random-access memory (RAM) 304, a read-only memory (ROM) 306, and a connector 308 compatible with the contacts 212 of the microcircuit card 201. In this example, the terminal 301 further includes man/machine interaction means 310 (for example a keyboard and a display screen).

It is assumed in the example described here that the card 201 and the terminal 301 use the EMV protocol. It must nevertheless be understood that the invention is not limited in any way to the EMV protocol and can be applied to any protocol.

One particular embodiment of the invention is described below with reference to FIGS. 2 to 4.

It is assumed in this example that the card 201 is a payment card inserted into the terminal 301 to effect a payment transaction. As explained in more detail below, the invention is not limited to payment transactions, however.

The card 201 and the terminal 301 are able to communicate with each other via the contact interface 212 of the card and the connector 308 of the terminal.

It is further assumed that the card 201 and the cardholder have been authenticated by the steps E101 and E107 represented in FIG. 1.

During a step E402, the card 201 receives a first GAC command GAC1 from the terminal 301. Reception of this command makes it possible to initiate a stage of continuing the transaction, this stage corresponding to a step of verifying the transaction.

According to the EMV protocol, the command GAC1 generated by the terminal 301 includes data describing the transaction in progress. To be more precise, this command results from concatenating data selected as a function of a CDOL sent by the card 201 to the terminal 301 during the previous step of authenticating the card. According to the EMV protocol, sending the command GAC1 makes it possible for the terminal 301 to receive in return a cryptogram indicating the response of the card 201 as to how the transaction is to continue.

When the command GAC1 has been received (step E402), the card 201 proceeds to a first verification step (step E404) to verify whether the terminal is in the mode without code verification. To this end, the microprocessor 202 determines whether a command VERIFY to verify a code entered by the holder of the card 201 was received during the preceding cardholder authentication step.

If the card 201 has received at least one command of this type from the terminal 301, the cardholder has entered at least one PIN during the step of authenticating the cardholder using the man/machine interaction means 310. Consequently, the card 201 deduces that the terminal is in the mode with code verification (and thus the card 201 likewise). In this situation the transaction can continue in the conventional way. The transaction in progress is no longer subject to the risks of fraud associated with transactions in the mode without code verification.

It is therefore assumed here that the card 201 determines during the step E404 that no VERIFY command has previously been received from the terminal 301 during the transaction. Consequently, the card 201 considers that the terminal 301 is functioning in the mode without code verification (and thus the card itself likewise). Under such circumstance, the card 201 initiates a step E405 of making the transaction secure.

In this example, the microprocessor 202 consults the non-volatile memory 208 to determine the history (H1) of preceding transactions of the card 201 in the mode without code verification (E406). In the situation described here, the history H1 in the non-volatile memory 208 includes a count CT of the number of transactions in the mode without code verification that the card 201 has previously effected. The history H1 also includes in this example a count CM of the cumulative total amount of transactions in the mode without code verification that the card 201 has previously effected.

When the values of the counts CT and CM have been determined, the microprocessor 202 performs a substep E406 of updating the history H1 by incrementing the count CT by 1 and incrementing the count CM by the amount of the transaction in progress (this amount being previously communicated by the terminal 301 in its command GAC1).

The card 201 then initiates a substep of securely processing the transaction in progress as a function at least of the history H1 in the non-volatile memory 208. To be more precise, the microprocessor 202 performs a verification substep (E408) to verify whether the following condition A is satisfied:
CT>CTmin; and
CM>CMmin
   where CTmin is a first predetermined limit number of transactions in the mode without code verification and CMmin is a first predetermined total amount limit for transactions in the mode without code verification.

CTmin and CMmin are defined beforehand by the issuer of the card 201, for example, and stored in the non-volatile memory 208. Also, to effect the verification substep E408, the processor 202 consults the non-volatile memory 208 in order to determine the values of CTmin and CMmin.

If condition A is not satisfied, the risks associated with the transaction in progress are deemed acceptable. The card 201 generates and then sends a TC cryptogram to advise the terminal 301 that it is accepting the transaction (step E410). In this situation, the terminal transmits the TC cryptogram to the card issuer, typically a remote server of the bank that issued the card 201.

In contrast, if the card 201 determines that condition A is satisfied, the card 201 generates and then sends an ARCQ cryptogram to the terminal 301 (step E412).

The card 201 then receives a second GAC command GAC2 from the terminal 301 (step E414), this command indicating whether it is possible for the transaction in progress to continue online. As indicated above, the terminal is not necessarily in a position to communicate with the issuer of the card 201 in order to continue the transaction online. For example, an online transaction is impossible if the terminal 301 is not in a position to connect to the server of the card issuer.

The card 201 then interprets the command GAC2 to determine whether the transaction can continue online (step E416).

If the command GAC2 received by the card 201 indicates that the request to continue the transaction online is accepted, the card 201 sends a TC cryptogram to the terminal 301 to advise the terminal that it is accepting the transaction (step E418).

In contrast, if the command GAC2 indicates to the card 201 that the request to continue the transaction online is refused, the card 201 continues the secure processing of the transaction in progress. In this example, the card 201 then verifies whether the following condition B is satisfied:
CT>CTmax; and
CM>CMmax
   where CTmax is a second predetermined limit number of transactions in the mode without code verification and CMmax is a second predetermined total amount limit for transactions in the mode without code verification. What is more, CTmax and CMmax are such that:
CTmin<CTmax; and
CMmin<CMmax

CTmax and CMmax are defined beforehand by the issuer of the card 201, for example, and stored in the non-volatile memory 208. Also, to effect the substep E416, the processor 202 consults the non-volatile memory 208 in order to determine the values of CTmax and CMmax.

If the card 201 determines that condition B is not satisfied, the risks associated with the transaction in progress are deemed acceptable. Consequently, the card 201 sends a TC cryptogram to the terminal 301 to advise the terminal that it is accepting the transaction (step 422).

In contrast, if the card 201 determines that condition B is satisfied, it sends an AAC cryptogram to the terminal 301 (step E424). This cryptogram advises the terminal 301 that the card 201 is refusing the transaction in progress. The risks associated with the transaction are considered too high.

As the transaction has been refused, the card 201 also updates the count CM stored in the history H1 of the non-volatile memory 208. To be more precise, the card 201 subtracts from the count CM the amount of the transaction in progress (step E426) in order not to include the amount of this transaction with future transactions.

The card 201 can also be configured to update the count CT during the step E426 in order not to take into account the fact that a transaction in the mode without code verification has been attempted. In this situation, the card 201 also decrements the count CT by 1 in the step E426.

The invention advantageously makes it possible to limit the risk of fraud if the card considers that the transaction in progress is being effected in the mode without code verification. As explained above, this type of transaction entails certain risks, resulting in particular from the emergence of MITM attacks.

The above implementation makes it possible to offer some degree of flexibility in making transactions in the mode without code verification secure. If condition A is satisfied, the card 201 does not necessarily refuse the transaction. The decision of the card 201 depends on the possibility (or impossibility) of continuing the transaction online with the issuer of the card or possibly on the result of the step E416. This mode is advantageous because the holder of a payment card may need to effect a series of offline transaction payments in the context of normal use of the card 201.

Continuing the transaction online (after the step E418) enables the card issuer to effect additional verifications, for example. The issuer can for example effect financial or antifraud verifications (to verify whether the card is registered as stolen, if the funds of the cardholder are sufficient given the amount of the transaction, etc.).

The invention is moreover advantageous in that it makes it possible to make transactions in the mode without code verification secure without modifying the normal operation of the terminal 301. The invention proposes to modify only the behavior of the card 201 by integrating into it a program of the invention. This has the advantage that it is not necessary to modify EMV payment terminals, which are very widespread at present. Replacing the installed base of EMV terminals would generate very high costs.

The FIG. 4 example represents only one possible implementation of the invention. Clearly the invention covers various other implementations.

For example, the issuer of the card 201 may advantageously preset the parameters of the card 201, to be more precise the program PG1 contained in the non-volatile memory 208, in order to implement management of fraud risks suited to the circumstances of the transaction concerned.

For example, it is possible to adapt the value of CTmin, CTmax, CMmin, and/or CMmax as a function in particular of the date and time and/or place of the transaction or as a function of the risk profile of the cardholder as previously determined by the card issuer.

In an alternative implementation, the card 201 is configured so that as soon as condition A is satisfied the card sends the terminal 301 an AAC cryptogram refusing the transaction. This implementation offers less flexibility than the FIG. 4 implementation but it makes it possible to raise the level of security of transactions that the card effects in the mode without code verification.

In a further implementation, if the card 201 determines in the step E404 that the terminal is in the mode with code verification, the card 201 proceeds to a step (step 428) of reinitializing the counts CT and CM. In other words, the card 201 resets the counts CT and CM to zero. This reinitialization advantageously makes it possible for the card 201 to count all successful transactions in the mode without code verification, whether completed online or offline. Alternatively, the card 201 may execute this step of reinitializing the counts as soon as a VERIFY command is received during the cardholder authentication stage.

Moreover, the program PG1 may configure the card 201 so that it verifies conditions A and/or B different from those described above. For example, condition A may be limited to CT>CTmin or to CM>CMmin. Similarly, condition B may be limited to CT>CTmax or CM>CMmax.

In a further implementation, the card 201 can be configured so that during the step E408 it takes account of additional elements (over and above the history H1).

Condition A can, for example, include:
M>Mmin
   where M is the individual amount of the transaction in progress and Mmin is a first limit amount for a transaction in the mode without code verification.

Moreover, condition B may include:
M>Mmax
   where M is the individual amount of the transaction in progress and Mmax is a second limit amount for a transaction in the mode without code verification. If Mmin and Mmax are taken into account in conditions A and B, respectively, then:
Mmin<Mmax

Mmin and Mmax are defined beforehand by the issuer of the card 201 and stored in the non-volatile memory 208, for example. Also, to verify whether M is greater than Mmin and/or whether M is greater than Mmax, the processor 202 consults the non-volatile memory 208 in order to determine Mmin and/or Mmax.

In a further implementation, the card 201 can verify whether conditions A and B are satisfied during the step E406, for example. The card 201 may then use the result obtained concerning condition B during the step E416, if necessary.

Moreover, if the card 201 implements the CCD option of the EMV protocol, it may advantageously insert a CVR message into its encrypted responses to the commands GAC1 and/or GAC2. Inserting CVR messages makes it possible to inform the terminal 301 and/or the issuer of the card 201 of the reasons behind decisions of the card 201 in response to received GAC commands. A CVR message may be sent to the bank issuing the card 201, for example, to be stored as audit information.

To be more precise, if an EMV card implements the CCD option, any of bits 1 to 4 in byte 3 of the CVR may be used to indicate an overshoot, for example. These four bits of the CVR are reserved for use by the card issuer. The bit used for this purpose may be set at 1, for example, if the card 201 wishes to indicate an overshoot of one or more overshoot limit values, and set at 0 otherwise.

Thus the card 201 can advantageously send the terminal 301 a CVR warning message in its response TC during the step E418 in order to indicate to the card issuer that only condition A is satisfied. In this way the issuer can be advised that the predetermined threshold(s) CTmin and/or CMmin have been exceeded, and where applicable that CTmax and CMmax have not been exceeded.

In the same way, the card 201 may insert a CVR warning message into its ARCQ cryptogram sent to the terminal in the step E412, this message indicating that condition A is satisfied (in other words, in this example, that CT>CTmin and CM>CTmin).

Similarly, the card 201 may insert a CVR warning message into its encrypted response AAC sent to the terminal 301 during the step E424, this message indicating that the predetermined thresholds CTmax and CMmax have been exceeded (condition B satisfied).

It is nevertheless feasible to insert warning messages into the responses of the card 201 to GAC commands even if the card does not implement the CCD option.

Moreover, if the card 201 implements the CCD option of the EMV protocol, the card may be configured to include two lists of objects (CDOl1 and CDOL2) in the records that it sends to the terminal 301 during the prior stage of authenticating the card (step E106). The object lists CDOL1 and CDOL2 correspond to the data that the terminal 301 must include in the commands GAC1 and GAC2, respectively.

The object list CDOL2 may in particular contain an object indicating that the terminal 301 must include an ARC (Authorization Response Code) message in the command GAC2 sent to the card 201. This ARC message is then received by the card 201 during the step E414 (if said step takes place). The card is then able, on the basis of the received ARC message, to determine during the step E416 whether continuing the transaction online is possible (or not).

In the implementations described with reference to FIG. 4, the microprocessor 202 executes the steps of the control method of the invention, in particular using the non-volatile memory 208 and the communications interface 212.

FIG. 6 represents a microcircuit card 601 that is a variant of the card 201 represented in FIG. 2.

The microcircuit card 601 includes a microprocessor 602, a random-access memory 604, a non-volatile memory 608, buses 606 and 610, and a communications interface 612 identical to those in the FIG. 2 card 201.

The hardware architecture of the card 601 differs from that of the card 201 only in that the card 601 further includes a near-field communications antenna 618 connected to the microprocessor 602. The microprocessor 602 and the near-field communications antenna 618 thus form a near-field communication circuit enabling contactless communication to be set up with an external device such as the terminal 301, for example. Thus it is possible to exchange data between the card 601 and an external device in accordance with the ISO 14 443 standard, for example.

The antenna 618 is formed by a plurality of electrically conductive turns, for example, defining an active area for receiving a magnetic field. By active area is meant the area of the antenna that, when a magnetic field crosses it, produces an induced current flowing in the antenna 618.

Thus the card 601 is able to effect a transaction by setting up communication with a device external to the communications interface means 612 (contact communications mode) or alternatively by means of the near-field communications antenna 618 (contactless communications mode).

The transactions in contactless communications mode are advantageous in that they save time and are simpler than transactions in contact communications mode. This is why it is assumed here that contactless communications mode transactions do not require the verification of a code during the cardholder authentication step.

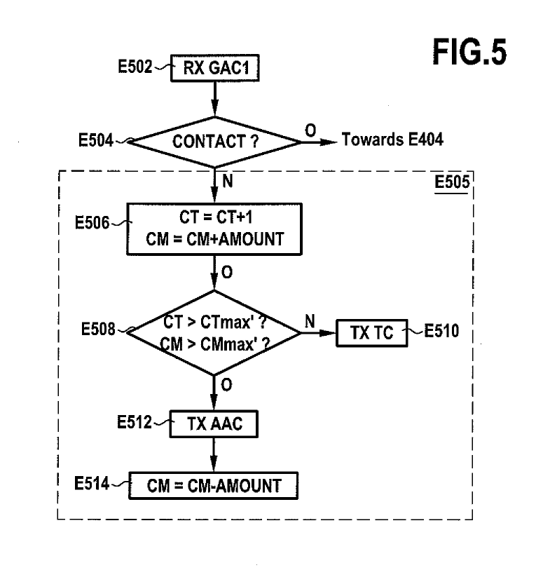

Moreover, the non-volatile memory 608 of the microcircuit card 601 constitutes an information medium of the invention. It contains a computer program PG2 of the invention, this program including instructions for implementing a control method of the invention the main steps E502 to E516 of which are represented in flowchart form in FIG. 5.

A second implementation of the invention is described below with reference to FIGS. 3, 5, and 6.

It is assumed in this example that the terminal 301 is able to communicate with the card 601 in both the contactless communications mode and the communications mode with contact.

It is further assumed that authenticating the card 601 and authenticating the cardholder have been carried out by the steps E101 and E107 represented in FIG. 1. During the step E502, the card 601 receives a GAC command (GAC1) from the terminal 301. As in the step E402, this command GAC1 prompts the card 601 to respond with an encrypted response indicating how the transaction should continue.

The card 601 then determines (E504) whether the transaction in progress is being effected in the communications mode with or without contact.

If the transaction is being effected in the contact communications mode, the card 601 can proceed to the step E404 described above and continue with the transaction as described with reference to FIG. 4.

In contrast, if the card 601 detects that the transaction is being effected in the contactless communications mode, it deduces that the transaction is in the mode without code verification and then initiates a step E505 for making the transaction secure.

To be more precise, the microprocessor 602 consults the non-volatile memory 608 to determine the history (H2) of preceding transactions of the card 601 in the mode without code verification (E506).

In the situation described here, the history H2 in the non-volatile memory 608 includes a count CT of the number of transactions in the mode without code verification that the card 601 has previously effected. In this example the history H2 also includes a count CM of the cumulative amount of transactions in the mode without code verification that the card 601 has previously effected.

Once the values of the counts CT and CM have been determined, the microprocessor 602 performs a substep (E506) of updating the history H2 by incrementing the count CT by 1 and incrementing the count CM by the amount of the transaction in progress (this amount being communicated beforehand by the terminal 301 in its command GAC1).

The card 601 then initiates a substep of securely processing the transaction in progress as a function at least of the history H2 in the non-volatile memory 608. To be more precise, the microprocessor 602 verifies whether the following condition B′ is satisfied (substep E508):
CT>CTmax′; and
CM>CMmax′
   where CTmax′ is a predetermined limit number of transactions in the mode without code verification and CMmax′ is a predetermined total limit amount for transactions in the mode without code verification.

CTmax′ and CMmax′ are defined beforehand by the issuer of the card 201, for example, and stored in the non-volatile memory 208. Thus, to effect the substep E508, the processor 602 consults the non-volatile memory 608 in order to determine the values of CTmax′ and CMmax′.

In one particular implementation, CTmax=CTmax′ and CMmax=CMmax′. In an alternative implementation, CTmax≠CTmax′ and CMmax≠CMmax′.

If condition B′ is not satisfied, the risks associated with the transaction in progress are considered acceptable. The card 601 generates and then sends a TC cryptogram to advise the terminal 301 that it is accepting the transaction (substep E510). In this situation, the terminal 301 transmits the TC cryptogram to the card issuer.

In contrast, if the card 601 determines that condition B′ is satisfied, the card generates and then sends an AAC cryptogram to the terminal 301 (substep E512). This cryptogram advises the terminal 301 that the card 601 is refusing the transaction in progress.

Furthermore, the card 601 updates the count CM by subtracting from it the amount of the transaction in progress (substep E514). As for the step E426, this operation makes it possible not to include in the count CM the amount of a transaction refused by the card 601.

The card 601 may furthermore reset the count CT by decrementing it by 1 in order not to take into account the transaction in progress that has failed.

The FIG. 5 implementation makes it possible to adapt the security level of a transaction as a function of the communications mode used. Payment terminals functioning in the contactless communications mode generally do not accept online transactions. This is why, in this implementation, the card 601 does not generate a request to continue the transaction online. The card 601 is configured to refuse a transaction systematically if condition B′ is satisfied.

It is clear that the variants described with reference to the FIG. 4 implementation apply in the same way to the FIG. 5 implementation. In particular, the issuer of the card 601 can adapt condition B′ in the same way as condition B as described above. Moreover, if the card 601 implements the CCD option of the EMV protocol, a CVR message could be inserted into the response of the card 601 to the command GAC1 from the terminal 301.

Moreover, the advantages stated with reference to the variants described with reference to FIG. 4 apply in the same way to the FIG. 5 implementation (and its variants).

The invention applies equally to a microcircuit card including a near-field communications antenna but having no contacts like those constituting the connection interface 612, for example. In this situation, the method may go directly from step E502 to step E506, for example.

Moreover, in the variants described with reference to FIG. 5, it is the microprocessor 602 that performs the steps of the control method of the invention, using in particular the non-volatile memory 608, the communications interface 612, and the near-field communications antenna 618.

The implementations described above apply to EMV payment cards. However, the invention is not limited to the EMV protocol and encompasses devices using other protocols. The invention applies in particular to microcircuit cards conforming to the ISO 7816 standard.

The invention also covers EMV devices that do not implement the CCD option.

More generally, the invention is not limited to payment transactions. The invention applies equally to other types of transaction using a device able to function in the mode with or without code verification to effect the transaction.

For example, the invention applies to a device able to function in the mode with or without code verification to execute a cardholder authentication transaction. In this situation, the control method of the invention does not concern itself with a transaction amount. If it is determined that the device is functioning in the mode without code verification, the step of making the transaction secure can for example consist in:
determining the number of preceding authentication transactions of the device in the mode without code verification;
securely processing the transaction as a function at least of the number of authentication transactions so determined; and
updating the number of authentication transactions so determined, for example by incrementing it by 1.

In contrast, the invention does not apply exclusively to microcircuit cards. The device of the invention may take the form of a USB key, for example. In one particular embodiment, the device of the invention is a portable (or “pocket”) device.

Moreover, the invention also applies to the situation in which during the cardholder authentication stage the optional code takes the form of a fingerprint. For example, in the implementation described with reference to FIG. 4, optional entry of a confidential code by the holder of the card 201 may be replaced by optional capture of the cardholder's fingerprint. The card 201 is then able to function both in the mode with code verification and in the mode without code verification, the code here taking the form of a fingerprint. In this situation, the terminal 301 includes fingerprint capture means. Moreover, the card 201 is able to verify the authenticity of the carrier by comparing a fingerprint captured by the terminal 301 with a fingerprint prestored in its non-volatile memory 208.

The invention finds applications in the field of secure access or transport, for example. The invention advantageously enables secure authentication of a user at regular intervals. The invention applies equally to a non-EMV electronic purse requiring secure verification of the cardholder at regular intervals.

What is claimed is:

1. A method of controlling a device able to function in a mode with code verification or in a mode without code verification to effect a transaction, said method including:
a step of authenticating the device;
an optional step of verifying a code; and
a stage of continuing the transaction;
wherein the method further includes a first verification step of verifying whether the device is functioning in the mode without code verification and, if so, said stage of continuing the transaction includes a step of making the transaction secure including:
a substep of determining a history of the preceding transactions of the device in the mode without code verification;
a substep of processing said transaction securely as a function at least of said history; and
a substep of updating the history.

2. A control method according to claim 1, wherein the determination step is effected after a step of receiving a cryptogram request during said stage of continuing the transaction.

3. A control method according to claim 1, wherein said transactions are payment transactions, said history including one or both of the following parameters:
the number of uses of the device in the mode without code verification; and
the cumulative amount of all transactions in the mode without code verification.

4. A control method according to claim 1, wherein the secure processing substep includes at least one of the following actions:
sending a request to continue said transaction online;
sending a warning message; and
rejecting the transaction.

5. A control method according to claim 3, wherein the secure processing substep includes:
a verification substep to verify whether the number of uses of the device in the mode without code verification exceeds a predetermined minimum number and if the cumulative amount of all transactions in the mode without code verification exceeds a predetermined minimum amount; and
if so, sending a request to continue said transaction online.

6. A control method according to claim 5, wherein a command is received in response to said request to continue the transaction online and the secure processing substep includes rejecting the transaction:
if said received command includes a parameter indicating refusal of said request to continue the transaction online;
if the number of uses of the device in the mode without code verification exceeds a predetermined maximum number; and
if the cumulative amount of all transactions in the mode without code verification exceeds a predetermined maximum number.

7. A control method according to claim 1, wherein said history is reinitialized if the result of the first verification step is negative.

8. A control method according to claim 1, wherein said device is able to effect a transaction in a contactless or contact communications mode, said mechanism for making the transaction secure being determined as a function of the communications mode used by the device.

9. A control method according to claim 6, wherein it is determined whether said request to continue online has been accepted as a function of the state of said parameter in said received command, the method further including a preliminary step of sending a request to insert said parameter in said command to be sent in response to said request to continue online.

10. A computer program including instructions for executing the steps of the control method according to claim 1 when said program is executed by a microprocessor.

11. A storage medium readable by a microprocessor and storing a computer program including instructions for executing the steps of the control method according to claim 1.

12. A device able to function in a mode with code verification or in a mode without code verification to effect a transaction, said device including:
means for authenticating said device;
means for verifying a code; and
means for continuing the transaction;
wherein the device includes verification means able to verify whether the device is functioning in the mode without code verification and, if so, to trigger means for making the transaction secure including:
means for determining a history of preceding transactions of said device in the mode without code verification;
means for processing said transaction securely as a function at least of said history; and
means for updating the history.
